(19) United States
(12) Patent Application Publication
(10) Pub. No.: US 2023/0332302 A1
(43) Pub. Date: Oct. 19, 2023

(54) HEAT RECOVERY DURING ELECTROLYSIS PROCESSES

(71) Applicant: Linde GmbH, Pullach (DE)

(72) Inventors: Andreas PESCHEL, Wolfratshausen (DE); Benjamin HENTSCHEL, München (DE)

(21) Appl. No.: 18/042,539

(22) PCT Filed: Jun. 23, 2021
(86) PCT No.: PCT/EP2021/025226

§ 371 Date: Feb. 22, 2023

(30) Foreign Application Priority Data
Aug. 27, 2020 (DE) 10 2020 005 242.8

(51) Int. Cl. C25B 1/04; C25B 15/08; C25B 15/021

(52) U.S. Cl. CPC C25B 1/04; C25B 15/083; C25B 15/021; C25B 15/087

(57) ABSTRACT

A method and system for electrolytically producing at least one product stream containing hydrogen, wherein a feed stream containing at least water is subjected to electrolysis so as to obtain two extraction streams. Downstream of the electrolysis, the two extraction streams are subjected to separation so as to obtain the at least one product stream and two liquid fractions containing water. At least one of the two liquid fractions is fed back at least in part to the electrolysis. Upstream of the electrolysis, the feed stream is heated by exchanging heat with at least one of the two extraction streams. The at least one extraction stream from which heat is removed by means of the heat exchange is subjected to additional cooling, the additional cooling taking place by using an organic Rankine cycle or a Rankine cycle that uses an organic-chemical heat transport medium.

The invention relates to a method for waste heat utilization during electrolysis processes and to a system for carrying out such a method.

### PRIOR ART

Hydrogen is often obtained from hydrocarbons, for example by steam reforming, which in light of the fight against climate change is no longer politically desirable in many places. Therefore, to reduce the carbon dioxide emissions, methods based on electrolysis, in particular of water, are increasingly used industrially for hydrogen production.

Other substances which play a key role in the energy sector or chemical industry can also be produced by electrolysis methods and thereby reduce the emissions of climate-active gases. For example, synthesis gas can be produced from carbon dioxide and water, and is conventionally produced by steam reforming of fossil hydrocarbons. Electrolysis as a production method thus enables renewable sources for these substances and can contribute to reducing the carbon dioxide content in the atmosphere. For example, by electrolysis of carbon dioxide, net-negative emissions of gases that contribute to climate warming are possible.

Various approaches are possible here, for example electrolysis in the form of an alkaline electrolysis (AEL) or an electrolysis on a proton exchange membrane (PEM) or anion exchange membrane (AEM), which can all be used in the form of low-temperature electrolysis, typically with operating temperatures of below 60° C. High-temperature electrolysis methods, for example using solid oxide electrolysis cells (SOEC), are also used for electrolysis, for example of water and/or carbon dioxide.

In principle, the following reactions occur during the electrolysis of water.

In the case of electrolysis with a PEM:

At the anode: H₂O→½O₂+2H⁺+2e⁻

At the cathode: 2e⁻+2H⁺→H₂

In the case of electrolysis with an AEM:

At the anode: 2OH⁻→½O₂+2H₂O+2e⁻

At the cathode: 2e⁻+2H₂O→H₂+2OH⁻

In the case of electrolysis with an SOEC:

At the anode: 2O²⁻→O₂+4e⁻

At the cathode: H₂O+2e⁻→H₂+O²⁻

The above-mentioned electrolysis of carbon dioxide can also be carried out as a low-temperature electrolysis on aqueous electrolytes. To put it generally, the following reactions take place:

At the cathode: CO₂+2e⁻+2M⁺+H₂O→CO+2MOH

At the anode: 2MOH→½O₂+2M⁺+2e⁻

During the electrolysis of carbon dioxide, too, the presence of water in the electrolyte solution partially results in the formation of hydrogen at the cathode in accordance with:

2H₂O+2M⁺+2e⁻→H₂+2MOH

Due to their high dynamics, the mentioned low-temperature electrolysis methods, in particular, are suitable for efficiently using renewable electrical energy, which is frequently subject to strong supply fluctuations, and at the same time to compensate for these supply fluctuations, which can additionally contribute to stabilizing corresponding power grids.

The waste heat produced during electrolysis often goes unused, which has an overall negative impact on the efficiency of the method. It is therefore desirable to provide an improved electrolysis concept in which waste heat is utilized as efficiently as possible.

### DISCLOSURE OF THE INVENTION

This object is achieved by methods and systems according to the independent claims. Advantageous developments of the invention are the subject matter of the dependent claims and of the following description.

The invention relates to a method for electrolytically producing at least one product stream containing hydrogen, wherein a feed stream containing at least water is subjected to electrolysis so as to obtain two extraction streams. Downstream of the electrolysis, the two extraction streams are subjected to separation so as to obtain the at least one product stream and two liquid fractions containing water. At least one of the two liquid fractions is fed back at least in part to the electrolysis. Upstream of the electrolysis, the feed stream is heated by exchanging heat with at least one of the two extraction streams. The at least one extraction stream from which heat is removed by means of the heat exchange is subjected to additional cooling, the additional cooling taking place by using at least one organic Rankine cycle or a Rankine cycle that uses an organic-chemical heat transport medium. The electrolysis is thus operated at a higher temperature level than is usually the case, because the cooling effect is lower as a result of the feed pre-heating. This brings about an increase in efficiency when the electrolysis is in operation. The higher temperature level of the electrolysis also produces the effect that waste heat is produced at a higher temperature than usual. An organic Rankine cycle can thus be used efficiently for waste heat recovery. This is not economically viable with conventional systems due to the lower operating temperatures of typically below 60° C.

The organic Rankine cycle (ORC) is based on a thermodynamic cycle according to Clausius-Rankine. This process is in principle identical to a conventional steam circuit in which water is evaporated by heating, the energy is removed by the performance of work, in particular mechanical work, and the steam is re-condensed in order to be fed back to the starting point of the cycle process. In contrast, during the organic Rankine cycle, another, in particular organic-chemical, working fluid which has a higher vapor pressure or lower boiling point than water is used instead of water. The working temperatures can thus be drastically reduced depending on the working fluid selected, so that even waste heat at a relatively low temperature level can be used, for example, for power generation by means of turbines. For high-temperature (HT) applications (T≥300° C.), the efficiency of this process is up to 20%, in special cases up to 24%. The lower the working temperature, the lower the efficiency of the process. For applications at medium process temperature (MT) (150° C.≥T≥110° C.), the efficiency for the conversion of heat into electrical current is about 7% to 8%. Low-temperature (LT) applications (110° C.≥T≥80° C.) achieve an efficiency of about 5%. Corresponding system components are offered by various companies. Series production in particular for the use of smaller amounts of heat has resulted in significant decreases in investment costs. For example, systems for using 1 MW heat are offered for generating 75 kW power, which equals an electrolysis input power of approximately 4 MW direct current.

It is provided here that a suitable working fluid is selected for ORC depending on the intended temperature range. They can include individual organic-chemical compounds or mixtures of different compounds.

Furthermore, depending on the specific configuration and embedding of the electrolysis method, different condensation media can be provided for the ORC. For example, it is possible to re-condense the working fluid using air, cooling water (e.g., river water or seawater), evaporating natural gas or evaporating hydrogen. Other cooling means are also possible, in particular those that are already present at the place of use.

The wording that the cooling is carried out “using” an ORC, is meant to express that the ORC does not have to be used solely for cooling, but also in particular that the medium used in the ORC does not itself have to flow through a heat exchanger used for cooling. Instead, it is also possible to use any heat transfer media between different heat exchangers.

Since the ORC cannot fully utilize the waste heat, the extraction stream remains at a temperature level increased compared to the fresh feed even after having passed through this cooling stage. According to the invention, this temperature difference is further utilized to preheat the feed stream that is supplied to the electrolysis. As already mentioned, this has the advantage that the electrolysis is to be operated more efficiently at a higher temperature; on the other hand, the extraction stream is advantageously cooled, so that, for example, water contained therein has a lower vapor pressure. This has an advantageous effect on the operation of the downstream separation, since the gaseous components of the extraction stream formed in the electrolysis are separated more effectively from the water present. Thus, drying steps that are conventionally downstream of the separation can be designed more efficiently or omitted completely. In addition, due to the heat exchange according to the invention, the system volume to be heated for a system start and thus also the start-up time required for the start is drastically reduced, since preferably only the electrolysis unit itself and the corresponding media guides between heat exchanger and electrolysis are operated at the increased electrolysis temperature level. The separation and the processing of the feed stream, on the other hand, preferably take place at a separation temperature level which can, in particular, substantially correspond to a natural external temperature, or it advantageously adjusts due to the energy balance between the corresponding system parts and the environment. Heat losses from these system parts thus have only a minor influence on the total energy balance of the method according to the invention and are negligibly small compared to conventional methods and systems. The separation temperature level is thus preferably between 10° C. and 60° C., preferably between 25° C. and 50° C., in particular about 30° C.

The electrolysis is preferably operated as low-temperature electrolysis at an electrolysis temperature level which is in a temperature range between 60° C. and 200° C., preferably between 70° C. and 150° C., particularly preferably between 80° C. and 110° C., in particular about 95° C. This makes it possible to use standard electrolysis methods for carrying out the method according to the invention, provided that they are easily adapted (e.g. increased pressure on the O2 side, so that water is not present in vaporous form). Even systems that are already in operation or installed can thus also be retrofitted for an operation according to the invention.

Alternatively, high-temperature electrolysis can also be applied, for example using a solid oxide electrolysis cell (SOEC). As a result, the waste heat can accumulate and be used at a significantly higher electrolysis temperature level, which is preferably between 300° C. and 1000° C., particularly preferably between 500° C. and 900° C., in particular 800° C., including the already mentioned advantageous efficiency increases in the area of waste heat utilization. Waste heat utilization can initially take place, for example, using a conventional steam turbine, wherein, in this case too, any remaining residual heat may be used for preheating the feed. In such configurations, waste heat utilization according to the invention by means of ORC can preferably take place downstream of feed preheating. Whether recycling the water into the feed stream is advantageous also for these configurations depends on the feedstocks and process conditions applied in the specific case, since steam stemming from external sources is often used for high-temperature electrolysis.

Advantageously, the feed stream is fed into the electrolysis by partially bypassing the heat exchange. As a result, the electrolysis temperature level can be set more precisely and overheating of the electrolysis can be avoided.

In addition, any additional waste heat can be removed from the system at an appropriate point of the process and used, for example, for the desalination of water contaminated with metal ions, for example in order to provide a purified fresh feed 1. This additional removal of waste heat can take place, for example, downstream of the ORC and/or upstream of the separation.

Advantageously, the recovery or utilization of process heat formed during electrolysis can take place both from an extraction stream on the anode and on the cathode side.

A further aspect of the invention proposes a system for carrying out the described method according to the invention. Advantageous configurations of the system according to the invention are adapted to carry out the developments of the method described above and below with respect to the attached drawings. The advantages described for the various configurations of the method therefore apply mutatis mutandis, and vice versa, to the corresponding system. Repetition of these advantages and configuration features is dispensed with only for the sake of clarity.

It is specifically pointed out once again that the methods and systems described herein can advantageously also be used for the electrolysis of carbon dioxide-containing feed streams and are expressly provided for this purpose. In such cases, the feed stream supplied to the electrolysis is gaseous.

Of course, the described methods and systems for waste heat utilization are also advantageous in connection with other electrolysis technologies, for example in order to increase the efficiency of chloralkali electrolysis or other electrolysis methods.

### BRIEF DESCRIPTION OF THE DRAWINGS

FIG. 1 shows a highly simplified schematic representation of a conventional electrolysis system or a conventional electrolysis method.

FIG. 2 schematically shows an advantageous electrolysis system with a feed-effluent heat exchanger and cooling of an extraction stream.

FIG. 3 shows a schematic representation of an advantageous configuration of a system according to the invention.

### DETAILED DESCRIPTION

In the following description, which refers in particular to the attached figures, components or method steps that are structurally or functionally similar are provided with identical reference signs and for reasons of clarity will not be explained again.

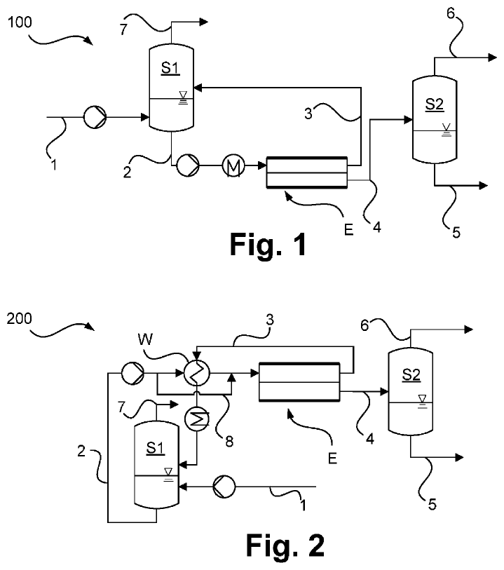

The electrolysis system 100 shown in FIG. 1 comprises an electrolysis unit E and two separators S1, S2. In operation, a feed stream 2 formed from a fresh feed 1 and from at least one liquid fraction deposited in the separators S1, S2 is conducted into the electrolysis unit E, for example with the aid of a pump.

Two extraction streams 3, 4 are taken from the electrolysis unit E and conducted each separately into one of the two separators S1, S2.

In the example shown herein, the feed stream 2 is a water-containing stream from which at least partially hydrogen and oxygen are generated in the electrolysis unit E. The oxygen is formed at the anode and is extracted together with the extraction stream 3 as anode stream 3 and fed into the separator S1.

The hydrogen, on the other hand, is formed at the cathode and fed into the separator S2 as cathode stream 4.

The liquid constituents of the anode stream 3 or cathode stream 4 are deposited as a liquid phase in the respective separator S1, S2, while the oxygen 7 and hydrogen 6 are discharged from the system 100 as gaseous product streams 6, 7. In the example shown, the liquid phase formed from the anode stream 3 is fed back to the feed stream 2, while the liquid phase 5 formed from the cathode stream is discarded and extracted from the system. However, it would also be possible to recycle the liquid phase 5 into the feed stream 2. To this end, it would have to be ensured that the liquid phase 5 does not contain any unsafe amounts of dissolved hydrogen, since they might otherwise react with residual oxygen still present in the feed stream 2 or with oxygen newly formed in the electrolysis unit E and could lead, for example, to unacceptably strong heating.

In the system 100 shown, the feed stream 2 is brought to a desired electrolysis temperature level upstream of the electrolysis unit E. For this purpose, a temperature control device is provided which is arranged, for example, downstream of the aforementioned pump and upstream of the electrolysis unit E.

The electrolysis temperature level is typically selected such that a suitable reaction temperature is present depending on the type of electrolysis unit E. If the electrolysis unit E is equipped, for example, with a proton exchange membrane (PEM) or an anion exchange membrane (AEM) or is provided in the form of an alkaline electrolysis (AEL), it is suitable in particular for low-temperature electrolysis, so that the electrolysis temperature level is typically selected in the range between 30° C. and 80° C. However, in the case of an electrolysis unit E with high-temperature electrolysis such as an SOEC (see above), temperatures in the range from 300° C. to 1000° C. are typically used. Accordingly, for example, it may take long until a corresponding liquid phase is deposited in the separators, or additional condensers are required.

In each case, further separation stages, such as separators, absorbers, dryers and other cleaning apparatuses, can be connected downstream of the separators S1, S2, for example in order to be able to provide on-spec products from the product streams 6, 7.

In comparison, a heat exchanger W according to the invention is provided in the system 200 shown in FIG. 2. As a result, the feed stream 2 can be heated to the electrolysis temperature level while recovering waste heat of the electrolysis unit E from the extraction stream 3. A bypass 8 can conduct some of the feed stream past the heat exchanger W, so that the electrolysis temperature can be set, for example, via a volume ratio of the corresponding partial streams of the feed stream 2. This can take place, for example, via a control loop or can be controlled automatically or manually. A further cooling of the extraction stream 3 is provided downstream of the heat exchanger W in order to cool the extraction stream to a separation temperature level. This has the advantage that, at low temperatures, only little water that is present in the separator S1 transitions into the gas phase. Thus, at a low separation temperature level, a preferably virtually anhydrous, but at least low-moisture product stream 7 can be taken from the separator S1.

A similar arrangement is conceivable also for the other extraction stream 4, and is also worthwhile in particular in the case of high-temperature electrolysis or alkaline electrolysis, since in these configurations a large amount of water (vapor) or alkaline solution is contained in the cathode stream 4, which is associated with a high heat output via the cathode stream 4 from the electrolysis unit E. This is due, for example, to the high specific heat capacity and/or evaporation enthalpy of water.

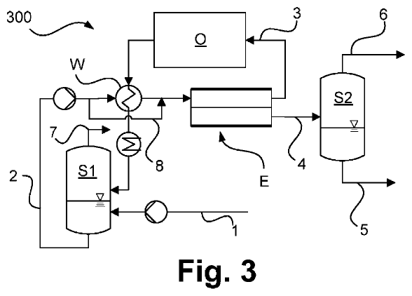

FIG. 3 finally is a schematic representation of an advantageous configuration of an electrolysis system 300 according to the invention. In this system 300, the cooling of the extraction stream 3 in addition to the heat exchanger W, which is provided here (like in system 200) in the form of a feed-effluent heat exchanger, comprises an organic Rankine cycle (ORC) O. The ORC O uses waste heat from the electrolysis unit E for generating electrical current, which, for example, can be fed, in turn, into the electrodes of the electrolysis unit E, possibly after corresponding rectification and/or transformation. Of course, the electrical current thus produced can also be used in any other way.

The ORC O is preferably arranged upstream of the heat exchanger W, since the temperature in the extraction stream 3 is the highest at that point and the ORC O can thus be operated with a particularly advantageous efficiency.

In the example shown here, a further cooling device is arranged also downstream of the feed-effluent heat exchanger W, which cooling device definitely cools the extraction stream 3 to the separation temperature level. This further cooling device can also be designed as a heat exchanger, for example, wherein the waste heat withdrawn here can be used, for example, for desalinating seawater or wastewater. This is advantageous, in particular, where water streams contaminated with salts are to be used as fresh feed 1 and first have to be prepared for this purpose.

1. A method for electrolytically producing at least one product stream containing hydrogen, wherein a feed stream containing at least water is subjected to electrolysis so as to obtain two extraction streams, wherein the two extraction streams are subjected to separation downstream of the electrolysis so as to obtain the at least one product stream and two liquid fractions containing water, wherein the feed stream is heated upstream of the electrolysis by exchanging heat with at least one of the two extraction streams, in that the at least one extraction stream from which heat is removed by means of the heat exchange is subjected to additional cooling, and in that the additional cooling takes place by using at least one organic Rankine cycle or at least one Rankine cycle that uses an organic-chemical heat transport medium.

2. The method according to claim 1, wherein the electrolysis is operated at an electrolysis temperature level and the separation is operated at a separation temperature level.

3. The method according to claim 2, wherein the electrolysis temperature level is within a temperature range between 60° C. and 200° C., preferably between 70° C. and 150° C., particularly preferably between 80° C. and 110° C., in particular 95° C.

4. The method according to claim 2, wherein the electrolysis temperature level is within a temperature range between 300° C. and 1000° C., preferably between 500° C. and 900° C., in particular 800° C.

5. The method according to claim 2, wherein the separation temperature level is within a temperature range between 20° C. and 100° C., preferably between 25° C. and 50° C., in particular 30° C.

6. The method according to claim 1, wherein at least one of the two liquid fractions is fed back at least in part to the electrolysis.

7. The method according to claim 1, wherein the feed stream is fed into the electrolysis by partially bypassing the heat exchange.

8. The method according to claim 1, wherein waste heat from the additional cooling is additionally used for desalinating a water stream, in particular the fresh feed.

9. The method according to claim 1, wherein the additional cooling and/or the heat exchange is applied to both extraction streams.

10. The method according to claim 1, wherein the feed stream additionally contains carbon dioxide and the product stream containing at least hydrogen additionally contains carbon monoxide.

11. A system for electrolytically producing at least one product stream containing hydrogen, which system comprises at least one electrolysis unit, a heat exchanger, an additional cooling unit and a separation unit, wherein the at least one electrolysis unit is configured to electrochemically convert a feed stream containing at least water at least partially using electrical energy so as to obtain two extraction streams containing gaseous electrolysis products, wherein the at least one separation unit is configured to separate the gaseous electrolysis products from liquid fractions contained in the extraction streams, wherein the at least one heat exchanger is configured to heat the feed stream using at least one of the two extraction streams, wherein the at least one extraction stream is cooled, and in that the cooling unit is configured to cool the at least one extraction stream cooled in the heat exchanger at least using an organic Rankine cycle or a Rankine cycle that uses an organic-chemical heat transport medium.

12. The system according to claim 11, further having means which are configured to carry out a method for electrolytically producing at least one product stream containing hydrogen, wherein a feed stream containing at least water is subjected to electrolysis so as to obtain two extraction streams, wherein the two extraction streams are subjected to separation downstream of the electrolysis so as to obtain the at least one product stream and two liquid fractions containing water, wherein the feed stream is heated upstream of the electrolysis by exchanging heat with at least one of the two extraction streams, in that the at least one extraction stream from which heat is removed by means of the heat exchange is subjected to additional cooling, and in that the additional cooling takes place by using at least one organic Rankine cycle or at least one Rankine cycle that uses an organic-chemical heat transport medium.
